(19) United States
(12) Patent Application Publication
(10) Pub. No.: US 2018/0339676 A1
(43) Pub. Date: Nov. 29, 2018

(54) SYSTEMS AND METHODS FOR DETERMINING DEVICE LOCATION FOR PASSIVE ENTRY AND VEHICLE STARTUP

(71) Applicant: GM Global Technology Operations LLC, Detroit, MI (US)

(72) Inventors: Marcelo LAZARINI, Macomb, MI (US); Alex SMITH, Madison Heights, MI (US)

(21) Appl. No.: 15/605,151

(22) Filed: May 25, 2017

(51) Int. Cl. B60R 25/24; F02N 11/08; H04W 4/04; G07C 9/00

(52) U.S. Cl. CPC B60R 25/24; F02N 11/0807; H04W 4/046; G07C 2009/00769; G07C 9/00309; B60R 2325/205; G07C 9/00007

(57) ABSTRACT

A passive entry and start system of a vehicle includes a transceiver configured to pair with a mobile device. The transceiver individually connects to and transmits predetermined signals from N different antennas of the vehicle that are located in N different positions. A location module determines a location of the mobile device relative to the vehicle based on M RSSI values of the predetermined signals received by the mobile device from M of the N different antennas of the vehicle. The location module is configured to determine a zone of the mobile device based on the location of the mobile device relative to the vehicle. The system further includes an unlock control module that actuates door lock actuators and unlocks the when the mobile device is in a first predetermined zone and a start control module that starts the vehicle when the mobile device is in a second predetermined zone.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle entry and start systems and more particularly to passive entry and start systems using a mobile device.

Vehicles using remote keyless systems include a key fob, smartphone, or other device that may be used to actuate electronic locks to control access to or starting of a vehicle without using a traditional mechanical key. When the key fob, smartphone, or other device is near the vehicle, pressing a button on the key fob or smartphone, or touching a vehicle door either locks or unlocks the vehicle doors. When the key fob, smartphone or other device is in the vehicle, a vehicle can be started by pushing a button or other actuator.

### SUMMARY

A passive entry and start system of a vehicle includes a transceiver configured to pair with a mobile device. The transceiver individually connects to and transmits predetermined signals from N different antennas of the vehicle that are located in N different positions. A location module determines a location of the mobile device relative to the vehicle based on M RSSI values of the predetermined signals received by the mobile device from M of the N different antennas of the vehicle. The location module is configured to determine a zone of the mobile device based on the location of the mobile device relative to the vehicle. The system further includes an unlock control module that actuates door lock actuators and unlocks the when the mobile device is in a first predetermined zone and a start control module that starts the vehicle when the mobile device is in a second predetermined zone.

In other features, the unlock control module is configured to actuate the door lock actuators of doors of the vehicle and unlocks doors of the vehicle when the mobile device is in the first predetermined zone without user input to the vehicle. In other features, the unlock control module actuates the door lock actuators of doors of the vehicle and unlocks doors of the vehicle when the mobile device is in the first predetermined zone and user input to unlock doors of the vehicle is received.

In other features, the passive entry and start system includes both the unlock control module and the start control module. In other features, the first predetermined zone includes an area within a predetermined distance of outsides of the vehicle. In other features, the second predetermined zone includes an area inside the vehicle. In other features, the passive entry and start system includes the multiplexer. The multiplexer includes one input and N outputs, each of the N outputs connected to one of the N different antennas and the one input connected to the transceiver.

In other features, the passive entry and start system includes a second transceiver that receives the M RSSI values from the mobile device and M unique identifiers of the M different antennas. The location module is configured to determine M predetermined locations of the M different antennas based on the M unique identifiers of the M different antennas, respectively. In other features, the transceiver is further configured to transmit N unique identifiers of the N different antennas via the N different antennas, respectively. In other features, the start control module is configured to start an internal combustion engine of the vehicle when the mobile device is in the second predetermined zone and user input to start the vehicle is received.

A method for unlocking and starting a vehicle includes pairing, by a transceiver of the vehicle, with a mobile device and individually connecting to and transmitting predetermined signals from N different antennas of the vehicle. The N different antennas are located in N different positions. N is an integer greater than or equal to one. The method includes determining a location of the mobile device relative to the vehicle based on M RSSI values determined by the mobile device based on M ones of the predetermined signals received by the mobile device from M of the N different antennas of the vehicle. M is an integer greater than or equal to one and is less than or equal to N. The method also includes determining a zone of the mobile device based on the location of the mobile device relative to the vehicle. The method further includes at least one of selectively actuating door lock actuators of doors of the vehicle and unlocking doors of the vehicle when the mobile device is in a first predetermined zone and starting the vehicle when the mobile device is in a second predetermined zone and user input to start the vehicle is received.

In other features, selectively actuating door lock actuators of doors of the vehicle and unlocking doors of the vehicle includes actuating the door lock actuators of doors of the vehicle and unlocking doors of the vehicle when the mobile device is in the first predetermined zone without user input to the vehicle. In other features, selectively actuating door lock actuators of doors of the vehicle and unlocking doors of the vehicle includes actuating the door lock actuators of doors of the vehicle and unlocking doors of the vehicle when the mobile device is in the first predetermined zone and user input to unlock doors of the vehicle is received. In other features, the at least one of selectively actuating the door lock actuators and starting the vehicle includes both selectively actuating the door lock actuators of doors of the vehicle and unlocking doors of the vehicle when the mobile device is in the first predetermined zone and starting the vehicle when the mobile device is in the second predetermined zone and user input to start the vehicle is received.

In other features, the first predetermined zone includes an area within a predetermined distance of outsides of the vehicle. In other features, the second predetermined zone includes an area inside the vehicle. In other features, the individually connecting to and transmitting predetermined signals from N different antennas of the vehicle includes individually connecting to and transmitting the predetermined signals from the N different antennas of the vehicle using a multiplexer including one input and N outputs, each of the N outputs connected to one of the N different antennas and the one input connected to the transceiver.

In other features, the method includes receiving the M RSSI values from the mobile device and M unique identifiers of the M different antennas. The method further includes determining M predetermined locations of the M different antennas based on the M unique identifiers of the M different antennas, respectively. Determining the location of the mobile device includes determining the location of the mobile device further based on the M predetermined locations of the M different antennas.

In other features, individually connecting to and transmitting predetermined signals further includes transmitting N unique identifiers of the N different antennas from the N different antennas, respectively. Determining the location of the mobile device includes determining the location of the mobile device further based M ones of the N unique identifiers received from the mobile device for the M RSSI values, respectively. In other features, starting the vehicle includes starting an internal combustion engine of the vehicle when the mobile device is in the second predetermined zone and user input to start the vehicle is received.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a passive entry and start system;

FIG. 2 is an example of zones around a vehicle;

FIG. 3 is a functional block diagram including a Bluetooth Low Energy (BLE) module in the passive entry and start system;

FIG. 4 is a functional block diagram of a control module of the BLE module;

FIG. 5 is a functional block diagram of a mobile device used to grant a user access to vehicle functions;

FIG. 6 is a flowchart depicting an example method of pairing and transmitting signals for a passive entry and start system;

FIG. 7 is a flowchart depicting an example method of transmitting signals from antennas of a vehicle for passive entry and start;

FIG. 8 is a flowchart depicting an example method of determining and transmitting received signal strength indication (RSSI)s for vehicle passive entry and start; and

FIG. 9 is a flowchart depicting an example method for performing passive entry and starting of a vehicle.

In the drawings, reference numbers may be reused to identify similar and/or identical elements.

### DETAILED DESCRIPTION

Passive entry and vehicle startup systems may include a Bluetooth low energy (BLE) module within a vehicle configured to advertise and pair with a mobile device. Further, the BLE module transmits data through a plurality of discrete antennas to the mobile device. The BLE module receives a received signal strength indicator (RSSI) from the mobile device to determine the location of the mobile device with respect to the vehicle. A single slave BLE transceiver handles signals from more than one antenna location rather than using a one to one relationship between antenna locations and slave transceivers.

When the mobile device is near the vehicle, pressing an exterior button on the vehicle or on the mobile device locks or unlocks the vehicle. When the mobile device is within the vehicle, the vehicle starts by pressing an interior button or other actuator. In this way, the mobile device acts as a traditional mechanical key.

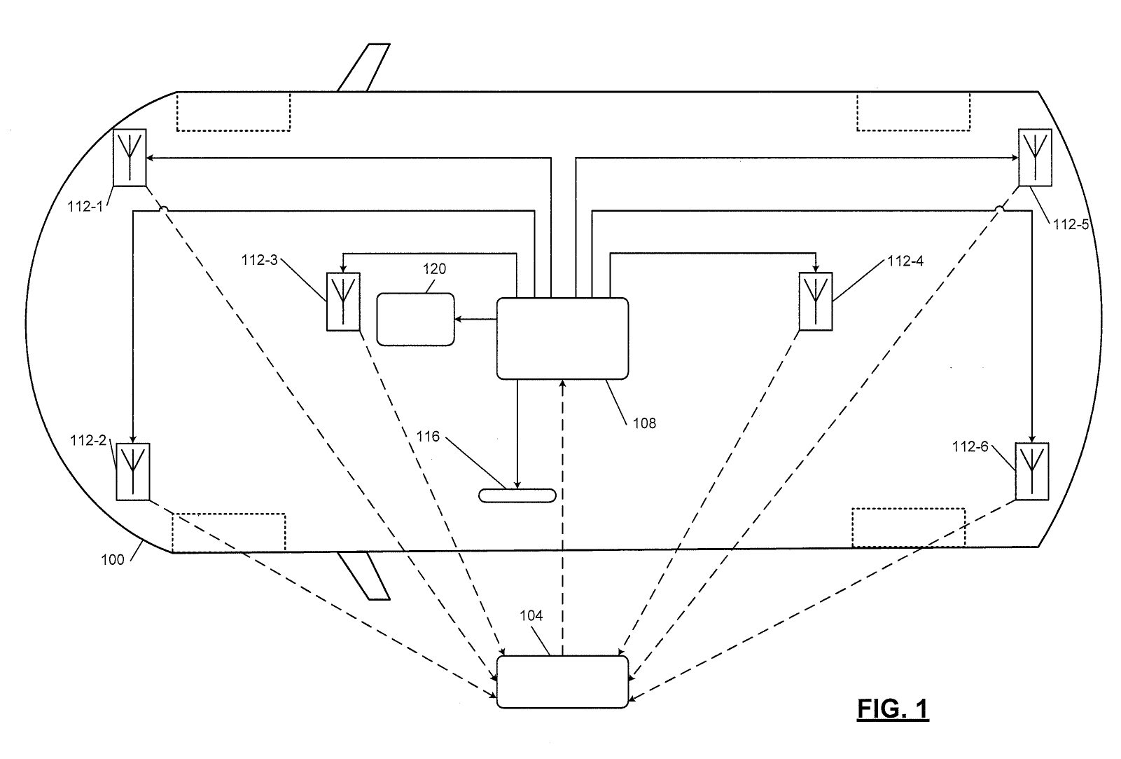

Referring to FIG. 1, a functional block diagram of a passive entry and start system is shown. Signals according to the Bluetooth Low Energy (BLE) protocol are generated at a predetermined radio frequency, such as 2.4 gigahertz (GHz) radio frequency or another frequency specified by the BLE protocol. Each of the following antennas may operate at the predetermined radio frequency.

A vehicle 100 connects with a mobile device 104 to allow passive locking and unlocking of door locks of the vehicle 100 and passive starting of the engine of the vehicle 100. The mobile device 104 may be a mobile phone, a tablet, or another type of wireless mobile electronic device. For purposes of discussion, the vehicle 100 may be locked or unlocked, and the engine of the vehicle 100 may be off.

The vehicle 100 includes a BLE module 108 and a plurality of BLE antennas 112-1, 112-2, 112-3, 112-4, 112-5, and 112-6, collectively referred to as BLE antennas 112, located throughout the vehicle 100. The BLE module 108 transmits data to the mobile device 104 through the BLE antennas 112. While six BLE antennas 112 are shown throughout the vehicle 100, as few as one or more than six BLE antennas 112 may be placed throughout the vehicle 100. The BLE module 108 is connected to the BLE antennas 112 via a twisted pair wire or a coaxial cable. Alternatively, the BLE module 108 may be connected via a vehicle communication bus. While a single BLE module 108 with two transceivers is shown below, additional BLE modules may be used by the vehicle 100 for other vehicle functions. The BLE module 108 may selectively wake up or shut down the vehicle communication bus as needed to reduce power consumption. In some examples, the vehicle communication bus includes a local interconnect (LIN) bus.

As can be seen in FIG. 1, the BLE antennas 112 are arranged in different locations of the vehicle 100. For example, BLE antenna 112-1 and 112-2 are arranged at opposite sides in the front of the vehicle 100, BLE antenna 112-5 and 112-6 are arranged at opposite sides in the rear of the vehicle 100, and BLE antenna 112-3 and 112-4 are arranged at front-middle and rear-middle portions of the vehicle 100.

The mobile device 104 is paired with the vehicle 100 by a user using a traditional pairing process or an application on the mobile device 104. The pairing can be manual or automatic (when the mobile device 104 includes an application that performs automatic pairing). Typically the manual pairing process includes triggering a pairing mode using vehicle and/or smartphone interfaces and selecting the vehicle 100 on the mobile device 104 interface (or vice versa). Some pairing processes may further require the use of a password or key to be entered into the vehicle 100 or mobile device 104 or retrieved from an online server.

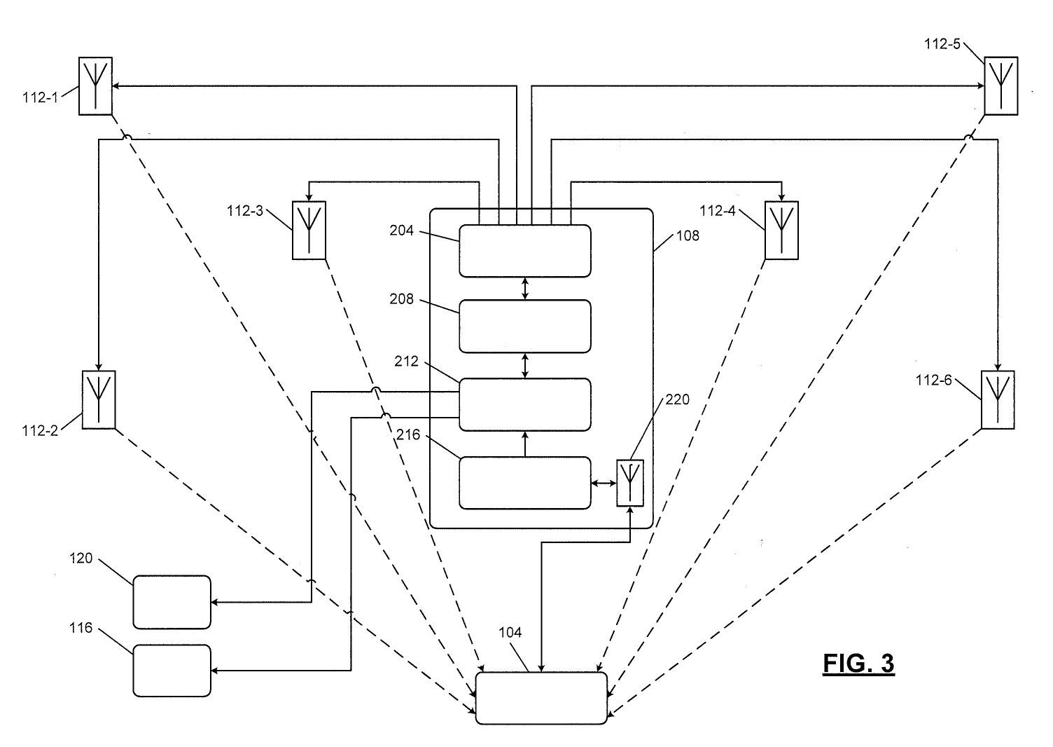

Once paired, the BLE module 108 is configured to selectively wirelessly transmit data to the mobile device 104 and receive data from the mobile device 104. During use, the BLE module 108 periodically advertises a connection. When the mobile device 104 is within a predetermined distance from the vehicle 100, the mobile device 104 pairs with the BLE module 108 and a connection is established. To identify a zone (or location and proximity) of the mobile device 104 relative to the vehicle 100, the BLE module 108 transmits a predetermined signal via a multiplexer (shown in FIG. 3) and the BLE antennas 112 to the mobile device 104. The BLE module 108 receives a response from the mobile device 104 including an RSSI and an identifier for the respective BLE antenna 112, indicating which BLE antenna 112 the BLE module 108 was transmitting through when the predetermined signal was transmitted.

In other words, the response from the mobile device 104 is transmitted to the BLE module 108, and the predetermined signal indicates the identity and the RSSI of the BLE antenna 112 that transmitted the predetermined signal. After the BLE module 108 receives the response transmitted through each of the BLE antennas 112, the BLE module 108 determines the zone (or the location and proximity) of the mobile device 104 relative to the vehicle 100 based on the RSSIs.

Alternatively, since the BLE antennas 112 are located around the vehicle 100, the BLE module 108 may calculate the location of the mobile device 104 with respect to a predetermined location of the vehicle 100, such as a center location of the vehicle 100, based on the identifier and the RSSIs. For example, the mobile device 104 is closer to one of the BLE antennas 112 when the RSSI for that one of the BLE antennas 112 increases. Conversely, the mobile device 104 is farther from one of the BLE antennas 112 when the RSSI determined based on the transmission for that one of the BLE antennas 112 decreases. When considering at least three different ones of the BLE antennas 112, the mobile device 104 may be located where circles (with radii drawn around the respective BLE antennas 112 based on their respective RSSIs) overlap or all touch.

The BLE module 108 transmits the predetermined signal (e.g., having predetermined characteristics and/or magnitude) via the BLE antennas 112 while the vehicle 100 is off. When transmitting the predetermined signal via one of the BLE antennas 112, the BLE module 108 also transmits an identifier of the one of the BLE antennas 112. For example, the passenger's side back BLE antenna 112-5 may include an identifier indicating a back, passenger's side location or an identifier indicating antenna number five. The predetermined signal and the identifier of the one of the BLE antennas 112 are transmitted from each of the BLE antennas 112 individually in the predetermined order.

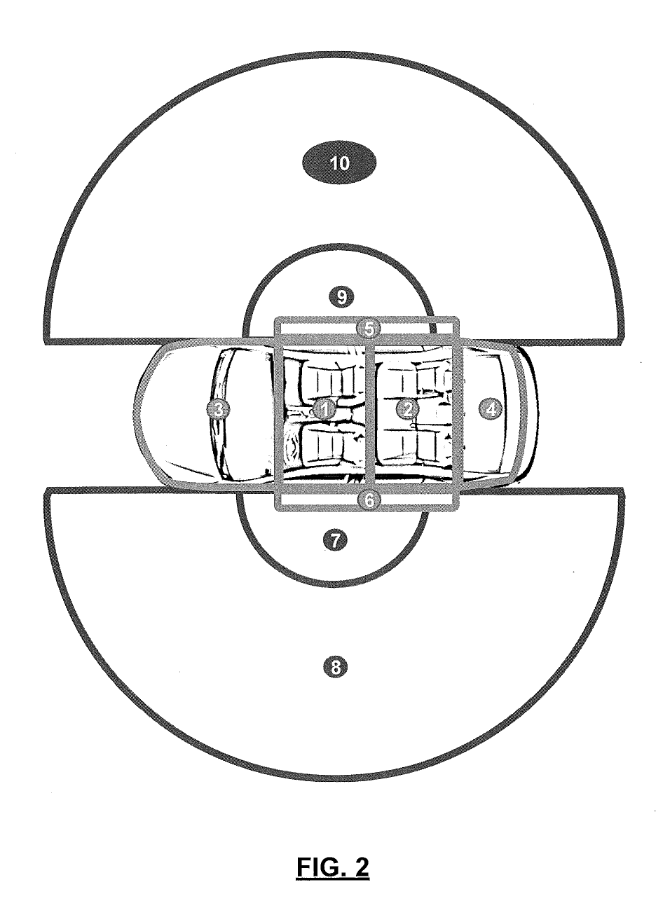

Referring to FIG. 2, an example of zones around the vehicle 100 is shown. Different vehicle functions are enabled or disabled depending upon the location and proximity of the mobile device 104 relative to the vehicle 100. In some examples, the location and proximity of the mobile device 104 is classified into different zones located inside and outside of the vehicle 100. For example in FIG. 2, zones 1-4 are inside of the vehicle 100 and zones 5-10 are located outside the vehicle 100. Certain vehicle functions are enabled when the mobile device 104 is located within a particular zone. For example, starting the ignition may be enabled when the mobile device 104 is located within zones 1 and 2 and disabled otherwise. For example, unlocking the doors may be enabled when the mobile device 104 is located in zones 5, 6, 7 or 9.

To identify a location of the mobile device 104 relative to the vehicle 100, the BLE module 108 may sequentially transmit the predetermined signal on the vehicle communication bus through each of the BLE antennas 112 to the mobile device 104.

The mobile device 104 sequentially receives the predetermined signals from the BLE antennas 112, measures received signal strength (RSS) of the predetermined signal, and generates the response including an RSS indicator (RSSI) for the predetermined signal and the identifier of the BLE antennas 112. The mobile device 104 sends the response to the BLE module 108, which stores the RSSI for each of the BLE antennas 112. After the BLE module 108 receives the RSSIs for all of the BLE antennas 112, the BLE module 108 determines the location of the mobile device 104 relative to the vehicle 100 based on the RSSIs and the known locations of the BLE antennas 112. The location can be determined based on relative RSSI strength and proximity based on RSSI magnitude. Alternately, the mobile device 104 can determine the location of the mobile device 104 relative to the vehicle 100 based on the RSSIs and the known location of the BLE antennas 112 and send the calculated location to the BLE module 108.

For example, when the mobile device 104 is located adjacent to a driver side of the vehicle 100 about midway between the front and rear of the vehicle 100, the BLE antennas 112-2 and 112-6 will have RSSIs having approximately the same magnitudes M₂ and M₆, respectively. Likewise, the BLE antennas 112-1 and 112-5 will also have similar (albeit lower) magnitudes M₁ and M₅, respectively. However, the magnitudes M₂ and M_{N} will be higher due to the closer proximity of the mobile device 104 to the BLE antennas 112-2 and 112-6 as compared to the BLE antennas 112-1 and 112-5. The BLE module 108 identifies the location of the mobile device 104 to be between the BLE antennas 112-1 and 112-2. The proximity is estimated based on the magnitude of the RSSIs. In this example, the mobile device 104 may be located within zones 6, 7 or 8 depending on the magnitude of the RSSIs.

In other words, the BLE module 108 sequentially transmits predetermined signals to the mobile device 104. The BLE module 108 may generate a dedicated key for each BLE antenna 112 for each transmission or the same key may be used for a predetermined number of successive transmissions. The BLE module 108 packages the key along with other data into the predetermined signal and transmits the data in a BLE “false” dummy broadcast transmission. In some examples, the broadcast channel can be the same as that used by the BLE module 108 or the broadcast channel can be changed every transmission or every predetermined number of transmissions to protect against jamming or relay attacks.

Alternatively, the BLE module 108 may connect to and transmit data from the BLE antennas 112 in a predetermined order. For example, the predetermined order may include numerical order, i.e., the BLE antenna 112-1, then the BLE antenna 112-2, then the BLE antenna 112-3, and so on until the BLE module 108 connects to 112-6, and then repeat. As another example, the predetermined order may include a reverse numerical order (e.g., from 6-1 then repeat), random where all of the BLE antennas 112 are each used once before being used a second time, or another predetermined order.

When the mobile device 104 is within a first predetermined zone, the vehicle 100 grants access to passive entry functions. For example, the vehicle 100 may automatically unlock the doors of the vehicle 100 when the mobile device 104 is within the first predetermined zone (e.g., when the mobile device 104 is located in zones 5, 6, 7 or 9). In various implementations, the BLE module 108 may actuate door lock actuators 116 and unlock the doors when the user touches or actuates one or more buttons on an exterior door of the vehicle 100 when the mobile device 104 is within zones 5, 6, 7 or 9. In this way, the user does not need a traditional mechanical key to unlock the vehicle 100.

The exterior button may be, for example, on one or more of the door handles of the vehicle 100. For example, one exterior button may be on the driver's side front door and/or on the passenger's side front door. In another implementation, when the doors of the vehicle 100 are unlocked and the mobile device 104 is within zones 5, 6, 7 or 9, the user actuating the exterior button may lock the doors of the vehicle 100. In various implementations, the BLE module 108 may also actuate the door lock actuators 116 and lock the doors when the mobile device 104 transitions out of zones 5, 6, 7 or 9.

The BLE module 108 may also start the engine via closing an ignition starter switch 120 when the user touches or actuates an interior button or switch and the mobile device 104 is within a second predetermined zone (e.g., when the mobile device 104 is located within zones 1 or 2). When the ignition starter switch 120 is closed, a starter motor may engage the engine and drive rotation of the engine to start the engine. The second predetermined zone may include when the mobile device 104 is within (a passenger cabin of) the vehicle 100. In this way, the user does not need to insert and actuate a traditional mechanical key to start the engine once inside the passenger cabin of the vehicle 100.

Referring to FIG. 3, a functional block diagram of the BLE module 108 in the passive entry and start system is shown. The BLE module 108 includes the multiplexer 204, a first transceiver 208, a control module 212, a second transceiver 216, and an antenna 220. The first transceiver 208 and the second transceiver 216 may be Bluetooth transceivers. For example only, the first and second transceivers 208 and 216 may be Toshiba TC35679 Ultra-Low Current Single-Chip Controllers for BLE (4.2) or another suitable BLE transceiver.

The multiplexer 204 is coupled to each of the BLE antennas 112. However, the multiplexer 204 only connects to one of the BLE antennas 112 at a time. The multiplexer 204 connects to each of the BLE antennas 112 in the predetermined order (e.g., sequentially).

When connected to one of the BLE antennas 112, the first transceiver 208 transmits the predetermined signal and a unique identifier (e.g., value) of the connected one of the BLE antennas 112 via the connected one of the BLE antennas 112. For example, the multiplexer 204 may connect to the front middle BLE antenna 112-3 at a time when following the predetermined order. When the multiplexer 204 is connected to the front middle BLE antenna 112-3, the first transceiver 208 transmits the predetermined signal and a unique identifier of the front middle BLE antenna 112-3 from the BLE antenna 112-3. As an example only, the multiplexer 204 may include a 1 input X output multiplexer, where X is the number of BLE antennas and each of the X outputs are connected to one of the X BLE antennas.

Next, the first transceiver 208 actuates the multiplexer 204 to connect to another one of the BLE antennas 112 according to the predetermined order. Once connected, the first transceiver 208 transmits the predetermined signal and the unique identifier of that one of the BLE antennas 112 via that one of the BLE antennas 112. The first transceiver 208 continues this process according to the predetermined order. The vehicle 100 may be in any power mode while the process continues.

The mobile device 104 determines an RSSI (value) each time a predetermined signal and unique identifier is received. For example, when the mobile device 104 receives the predetermined signal transmitted from the front middle BLE antenna 112-3, the mobile device 104 determines an RSSI for the front middle BLE antenna 112-3 based on the predetermined signal. The mobile device 104 determines the RSSI, for example, using one of an equation and a lookup table that relates one or more characteristics (e.g., magnitude, power) of the predetermined signal to RSSI.

The mobile device 104 transmits the RSSIs and the respective unique identifiers of the ones of the BLE antennas 112 to the second transceiver 216 via the antenna 220. The control module 212 determines the location of the mobile device 104 relative to the predetermined location of the vehicle 100 based on the RSSIs determined for ones of the BLE antennas 112 and the respective (predetermined) locations of the ones of the BLE antennas 112. That is, based on the locations of the ones of the BLE antennas 112 and the RSSIs determined for the ones of the BLE antennas 112, the location of the mobile device 104 may be triangulated.

When the mobile device 104 is within the first predetermined zone, the control module 212 allows unlocking of the doors of the vehicle. For example, the control module 212 may automatically (and without user input) actuate the door lock actuators 116 and unlock the doors of the vehicle 100 when the mobile device 104 is within the first predetermined zone. In various implementations, the control module 212 may actuate the door lock actuators 116 and unlock the doors of the vehicle 100 in response to receipt of user input (e.g., to a button on an exterior of the vehicle) when the mobile device 104 is within the first predetermined zone. In some implementations, the first predetermined zone may be large enough to accommodate for the circumstance when an individual who is not carrying the mobile device 104 is pressing the exterior button.

When the mobile device 104 is within the second predetermined zone, the control module 212 actuates (close) the ignition starter switch 120 in response to receipt of user input (e.g., to a button within the passenger compartment). When the ignition starter switch 120 is actuated, the starter motor engages the engine and applies power to the starter motor to drive rotation of the engine.

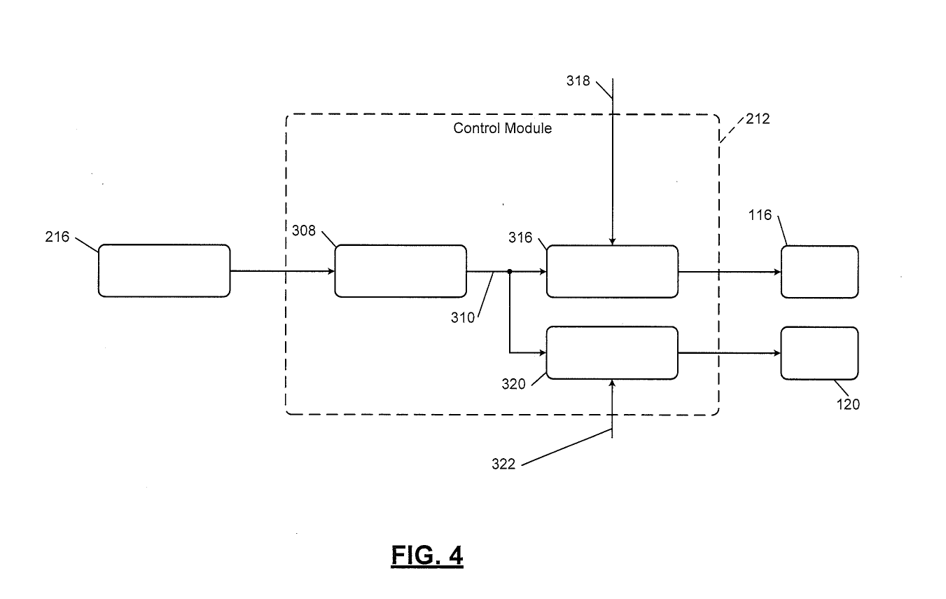

Referring to FIG. 4, a functional block diagram of the control module 212 is shown. The control module 212 may include a location module 308, an unlock control module 316, and a start control module 320. As discussed above, the mobile device 104 is paired with the vehicle 100 by the user using a traditional pairing process or an application on the mobile device 104. The pairing can be manual or automatic (when the mobile device 104 includes an application that performs automatic pairing).

Once paired, the location module 308 receives, from the mobile device 104, the RSSIs and the respective unique identifiers of ones of BLE antennas 112. More specifically, along with an RSSI, the location module 308 also receives a unique identifier of the one of the BLE antennas 112 from which the predetermined signal was transmitted for the determination of the RSSI.

Using at least one of one or more equations and/or lookup tables for triangulation, based on the predetermined locations of the BLE antennas 112 (relative to the predetermined location of the vehicle 100) and the respective RSSIs, the location module 308 determines a location 310 of the mobile device 104. For example, when the mobile device 104 is closer to one of the BLE antennas 112, the RSSI for that one of the BLE antennas 112 will be greater. Conversely, when the mobile device 104 is further from one of the BLE antennas 112, the RSSI for that one of the BLE antennas 112 will be lesser. Using multiple different ones of the BLE antennas 112, the predetermined positions of those ones of the BLE antennas 112, and the RSSIs determined based on transmission from those ones of the BLE antennas 112, the location module 308 determines the location 310 of the mobile device 104, including which zone the mobile device 104 is in.

The unlock control module 316 determines whether the mobile device 104 is within the first predetermined zone. The unlock control module 316 may actuate the door lock actuators 116 to unlock the doors of the vehicle 100 when the mobile device 104 is within the first predetermined zone. In various implementations, the unlock control module 316 actuate the door lock actuators 116 to unlock the doors of the vehicle 100 when both (i) the mobile device 104 is within the first predetermined zone and (ii) user input 318 to unlock the doors has been received, such as via user actuation or touching of a button on an exterior (e.g., of a door) of the vehicle.

The start control module 320 determines whether the mobile device 104 is within the second predetermined zone. The start control module 320 selectively actuates (closes) the ignition starter switch 120 to start the engine of the vehicle 100 based on the location of the mobile device 104. More specifically, the start control module 320 selectively actuates (closes) the ignition starter switch 120 to start the engine of the vehicle 100 when both (i) the mobile device 104 is within the second predetermined zone and (ii) user input 322 to unlock the doors has been received. The user input 322 may be received, for example, in response to user actuation or touching of an ignition button or switch located within the passenger cabin of the vehicle 100.

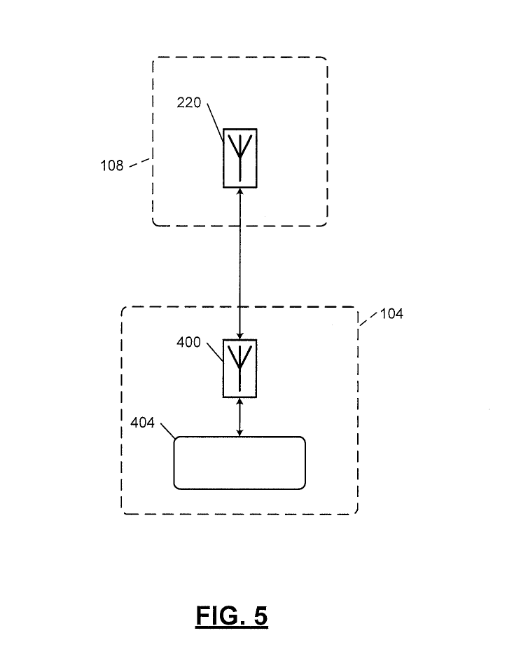

Referring to FIG. 5, a functional block diagram of the mobile device 104 is shown. The mobile device 104 includes one or more antennas, such as device antenna 400, and a RSSI module 404. For each predetermined signal received, the RSSI module 404 determines the RSSI based on characteristics of the predetermined signal. For example, the RSSI module 404 may determine the RSSI using one or more equations and/or lookup tables that relate characteristics of the predetermined signal to RSSI.

As discussed above, a unique identifier of the one of the predetermined BLE antennas 112 from which the predetermined signal was transmitted is transmitted along with the predetermined signal. Thus, the RSSI module 404 has a unique identifier of one of the BLE antennas 112 for each RSSI determined. The RSSI module 404 transmits the RSSI and its respective unique identifier of one of the BLE antennas 112 for determination of the location 310 of the mobile device 104, as described above.

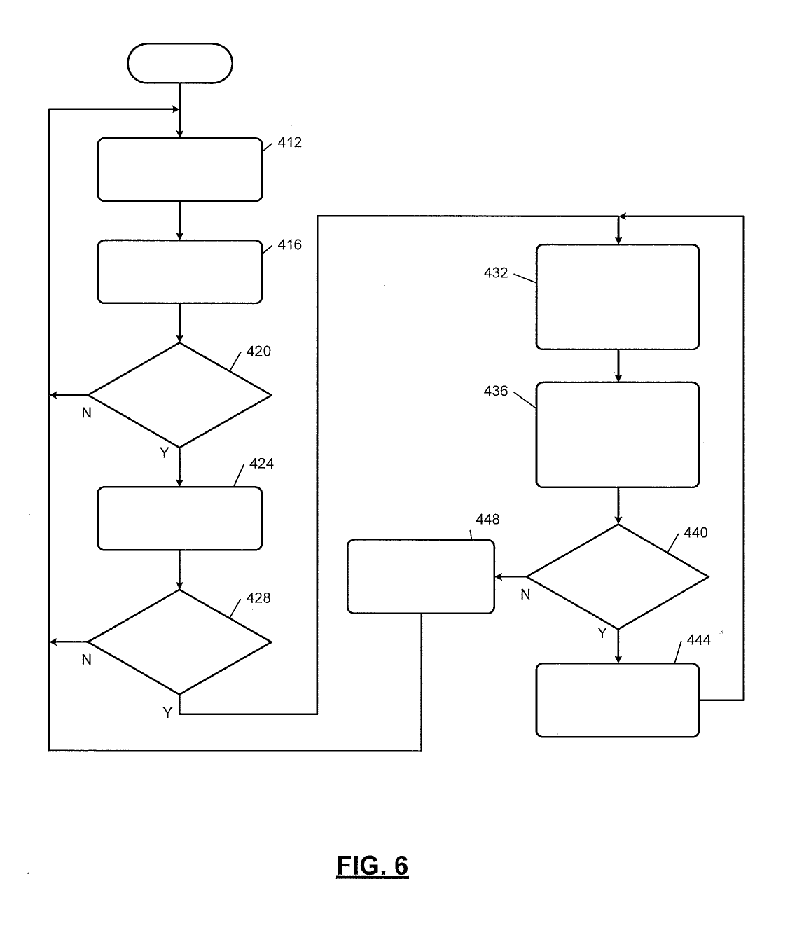

Referring to FIG. 6, a flowchart depicting an example method of pairing and transmitting signals for the passive entry and start system is shown. At 412, the BLE module 108 is in a low power mode. At 416, the BLE module 108 periodically advertises the BLE network. At 420, the method determines whether the BLE module 108 detects the mobile device 104. If 420 is true, the BLE module 108 is transitioned to full power mode at 424. At 428, the method detects whether the mobile device 104 is paired with the vehicle 100. If either 420 or 428 are false, the method returns to 412.

If 428 is true, the BLE module 108 connects to the BLE antennas 112 in the predetermined order (e.g., sequentially) and transmits the predetermined signal at 432. The predetermined signal can include security data such as keys, rolling codes, etc. via the vehicle bus. The predetermined signal can also include the identifier for the respective BLE antenna 112, channel selection information, etc. The identifier for the respective BLE antenna 112 uniquely identifies the BLE antenna 112 that sent the predetermined signal.

At 436, the mobile device 104 receives the predetermined signal from the respective BLE antennas 112, generates an RSSI for the respective BLE antenna, and transmits the RSSI back to the BLE module 108. At 440, the method determines whether there are additional BLE antennas 112. If 440 is true, the method selects the next BLE antenna 112 at 444 and continues at 432. When 440 is false, the BLE module 108 determines the location of the mobile device 104 based on the RSSIs and the position of the BLE antennas 112 throughout the vehicle 100 at 448.

Referring to FIG. 7, a flowchart depicting an example method of transmitting signals from the BLE antennas 112 for passive entry and start is presented. The example of FIG. 7 may be performed while the vehicle 100 (and the engine) is in any power mode, such as on or off. Control begins with 504 where the first transceiver 208 sets a counter value (X) equal to 1. At 508, the first transceiver 208 actuates the multiplexer 204 to connect to the X-th one of the BLE antennas 112. The first transceiver 208 transmits the predetermined signal and the unique identifier of the X-th one of the BLE antennas 112 from the X-th one of the BLE antennas 112 at 512.

At 516, the first transceiver 208 determines whether the counter value (X) is equal to the total number of the BLE antennas 112 of the vehicle. For example, in the example of the 6 BLE antennas 112-1, 112-2, 112-3, 112-4, 112-5, and 112-6, the first transceiver 208 determines whether the counter value (X) is equal to 6. If 516 is true, control returns to 504. If 516 is false, the first transceiver 208 increments the counter value X (e.g., sets X=X+1) at 520, and control returns to 508.

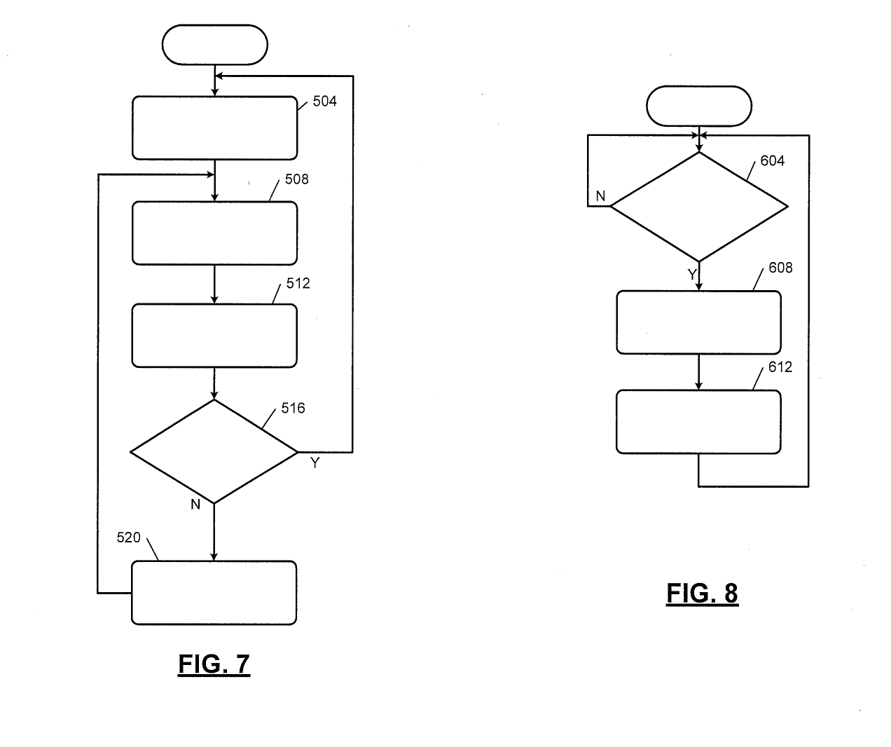

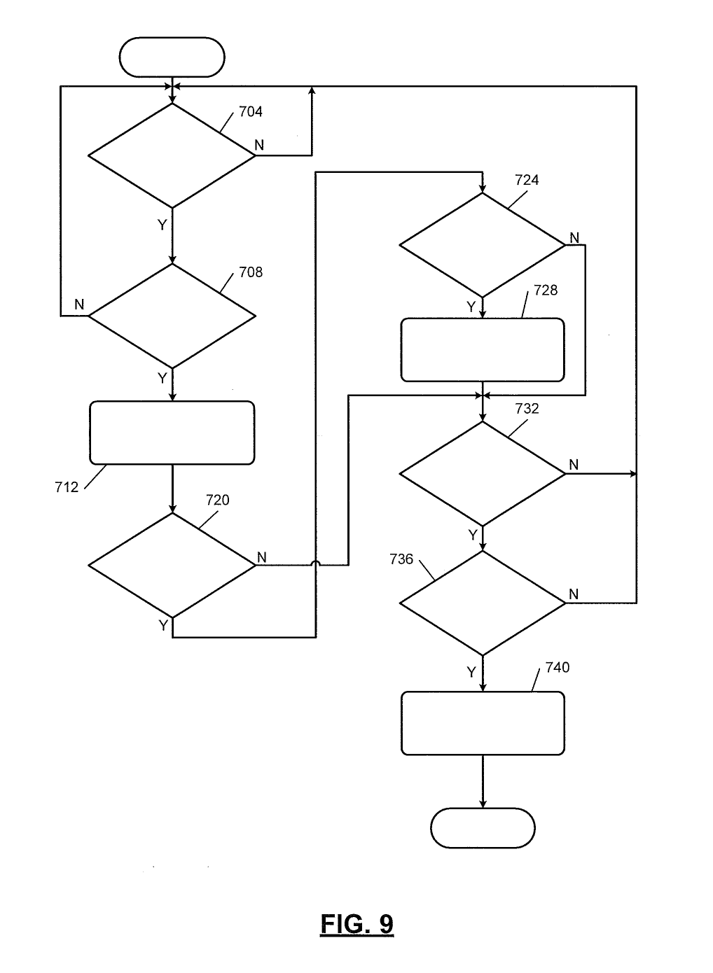

FIG. 8 includes a flowchart depicting an example method of determining and transmitting RSSIs for passive entry and start. Control begins with 604 where the RSSI module 404 determines whether a predetermined signal and a unique identifier of one of the BLE antennas 112 of the vehicle 100 have been received. If 604 is true, control continues with 608. If 604 is false, control may remain at 604.

At 608, the RSSI module 404 determines an RSSI (value) based on the characteristics of the predetermined signal. At 612, the RSSI module 404 transmits the RSSI and the unique identifier of the one of the BLE antennas 112 to the vehicle 100 for determination of the location 310 of the mobile device 104. Control returns to 604 for receipt of a next predetermined signal. In various implementations, the example of FIG. 8 may be performed in response to the mobile device 104 pairing with the vehicle 100.

FIG. 9 is a flowchart a flowchart depicting an example method of performing passive entry and starting of the vehicle 100. Control begins when the vehicle 100 (and the engine) is off. Alternatively, control may begin when the vehicle 100 is in any power mode. In various implementations, the example of FIG. 9 may be performed in response to the mobile device 104 being paired with the vehicle 100.

At 704, the second transceiver 216 determines whether an RSSI and a unique identifier of one of the BLE antennas 112 have been received from the mobile device 104. If 704 is true, control continues with 708. If 704 is false, control may remain at 704.

The location module 308 may determine whether an RSSI has been received for at least a predetermined number of different ones of the BLE antennas 112 at 708. For example, the location module 308 may determine whether an RSSI has been received for at least three different ones of the BLE antennas 112 at 708. Use of RSSIs for more than three different BLE antennas may improve the accuracy of a location determined based on the locations of the antennas and the RSSIs. If 708 is true, control continues with 712. If 708 is false, control returns to 704 to collect more RSSI data for one or more other BLE antennas. If two different RSSIs are received for the same one of the BLE antennas 112 at two different times, the location module 308 may discard the one of the RSSIs received first (earlier) in time and use the one of the RSSIs received second (later) in time.

At 712, the location module 308 determines the location 310 of the mobile device 104 relative to the vehicle 100 based on the RSSIs determined for the at least three different ones of the BLE antennas 112 and the predetermined locations (relative to the vehicle 100) of the at least three different ones of the BLE antennas 112. The location module 308 determines which zone the mobile device 104 is in.

At 720, the unlock control module determines if the mobile device is located in zones 5, 6, 7 or 9. If 720 is true, control may continue to 724. Alternatively, if 720 is true, control may transfer to 728. If 720 is false, control may transfer to 732, which is discussed further below. Alternatively, if 720 is false, control may return to 704.

At 724, the unlock control module 316 may determine whether the user input 318 has been received to unlock the doors of the vehicle 100. If 724 is true, control may continue to 728. If 724 is false, control may transfer to 732. The unlock control module 316 actuates the door lock actuators 116, thereby unlocking the doors of the vehicle 100 at 728.

At 732, determines if the mobile device is located in zones 1 or 2. If 732 is true, control may continue with 736. If 732 is false, control may return to 704. The start control module 320 determines whether the user input 322 to start the engine of the vehicle 100 has been received at 736. If 736 is true, the start control module 320 actuates (closes) the ignition starter switch 120 at 740, and control may end. If 736 is false, control may return to 704.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the implementations is described above as having certain features, any one or more of those features described with respect to any implementation of the disclosure can be implemented in and/or combined with features of any of the other implementations, even if that combination is not explicitly described. In other words, the described implementations are not mutually exclusive, and permutations of one or more implementations with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A passive entry and start system of a vehicle, comprising:
a transceiver configured to:
pair with a mobile device; and
via a multiplexer, individually connect to and transmit predetermined signals from N different antennas of the vehicle that are located in N different positions,
wherein N is an integer greater than or equal to one;
a location module configured to determine a location of the mobile device relative to the vehicle based on:
M RSSI values determined by the mobile device based on M ones of the predetermined signals received by the mobile device from M of the N different antennas of the vehicle, wherein M is an integer greater than or equal to one and is less than or equal to N, and
the location module is configured to determine a zone of the mobile device based on the location of the mobile device relative to the vehicle; and
at least one of:
an unlock control module configured to selectively actuate door lock actuators of doors of the vehicle and unlocks doors of the vehicle when the mobile device is in a first predetermined zone; and
a start control module configured to start the vehicle when the mobile device is in a second predetermined zone and user input to start the vehicle is received.

2. The passive entry and start system of claim 1 wherein the unlock control module is configured to actuate the door lock actuators of doors of the vehicle and unlocks doors of the vehicle when the mobile device is in the first predetermined zone without user input to the vehicle.

3. The passive entry and start system of claim 1 wherein the unlock control module actuates the door lock actuators of doors of the vehicle and unlocks doors of the vehicle when the mobile device is in the first predetermined zone and user input to unlock doors of the vehicle is received.

4. The passive entry and start system of claim 1 wherein the passive entry and start system includes both the unlock control module and the start control module.

5. The passive entry and start system of claim 1 wherein the first predetermined zone includes an area within a predetermined distance of outsides of the vehicle.

6. The passive entry and start system of claim 1 wherein the second predetermined zone includes an area inside the vehicle.

7. The passive entry and start system of claim 1 further comprising the multiplexer, wherein the multiplexer includes one input and N outputs, each of the N outputs connected to one of the N different antennas and the one input connected to the transceiver.

8. The passive entry and start system of claim 1 further comprising a second transceiver that receives the M RSSI values from the mobile device and M unique identifiers of the M different antennas,
wherein the location module is configured to determine M predetermined locations of the M different antennas based on the M unique identifiers of the M different antennas, respectively.

9. The passive entry and start system of claim 1 wherein the transceiver is further configured to transmit N unique identifiers of the N different antennas via the N different antennas, respectively.

10. The passive entry and start system of claim 1 wherein the start control module is configured to start an internal combustion engine of the vehicle when the mobile device is in the second predetermined zone and user input to start the vehicle is received.

11. A method for unlocking and starting a vehicle, comprising:
pairing, by a transceiver of the vehicle, with a mobile device;
individually connecting to and transmitting predetermined signals from N different antennas of the vehicle, wherein the N different antennas are located in N different positions, and wherein N is an integer greater than or equal to one;
determining a location of the mobile device relative to the vehicle based on:
M RSSI values determined by the mobile device based on M ones of the predetermined signals received by the mobile device from M of the N different antennas of the vehicle, wherein M is an integer greater than or equal to one and is less than or equal to N;
determining a zone of the mobile device based on the location of the mobile device relative to the vehicle; and
at least one of:
selectively actuating door lock actuators of doors of the vehicle and unlocking doors of the vehicle when the mobile device is in a first predetermined zone; and
starting the vehicle when the mobile device is in a second predetermined zone and user input to start the vehicle is received.

12. The method of claim 11 wherein selectively actuating door lock actuators of doors of the vehicle and unlocking doors of the vehicle includes actuating the door lock actuators of doors of the vehicle and unlocking doors of the vehicle when the mobile device is in the first predetermined zone without user input to the vehicle.

13. The method of claim 11 wherein selectively actuating door lock actuators of doors of the vehicle and unlocking doors of the vehicle includes actuating the door lock actuators of doors of the vehicle and unlocking doors of the vehicle when the mobile device is in the first predetermined zone and user input to unlock doors of the vehicle is received.

14. The method of claim 11 wherein the at least one of selectively actuating the door lock actuators and starting the vehicle includes both:
selectively actuating the door lock actuators of doors of the vehicle and unlocking doors of the vehicle when the mobile device is in the first predetermined zone; and
starting the vehicle when the mobile device is in the second predetermined zone and user input to start the vehicle is received.

15. The method of claim 11 wherein the first predetermined zone includes an area within a predetermined distance of outsides of the vehicle.

16. The method of claim 11 wherein the second predetermined zone includes an area inside the vehicle.

17. The method of claim 11 wherein the individually connecting to and transmitting predetermined signals from N different antennas of the vehicle includes individually connecting to and transmitting the predetermined signals from the N different antennas of the vehicle using a multiplexer including one input and N outputs, each of the N outputs connected to one of the N different antennas and the one input connected to the transceiver.

18. The method of claim 11 further comprising:
receiving the M RSSI values from the mobile device and M unique identifiers of the M different antennas; and
determining M predetermined locations of the M different antennas based on the M unique identifiers of the M different antennas, respectively,
wherein determining the location of the mobile device includes determining the location of the mobile device further based on the M predetermined locations of the M different antennas.

19. The method of claim 11 wherein:
individually connecting to and transmitting predetermined signals further includes transmitting N unique identifiers of the N different antennas from the N different antennas, respectively; and
wherein determining the location of the mobile device includes determining the location of the mobile device further based M ones of the N unique identifiers received from the mobile device for the M RSSI values, respectively.

20. The method of claim 11 wherein starting the vehicle includes starting an internal combustion engine of the vehicle when the mobile device is in the second predetermined zone and user input to start the vehicle is received.
